(19) United States
(12) Patent Application Publication
(10) Pub. No.: US 2009/0227694 A1
(43) Pub. Date: Sep. 10, 2009

(54) METHOD FOR THE TREATMENT OF POLYURETHANE FOAM WITH MICROWAVE RADIATION

(75) Inventors: Frithjof Hannig, Duesseldorf (DE); Dagmer Ulbrich, Monheim am Rhein (DE); Peter Nordmann, Dormagen (DE); Martina Jaeger, Koeln (DE); Joern Beaujean, Koeln (DE); Wolfgang Friederichs, Koeln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/398,679

(22) Filed: Mar. 5, 2009

(30) Foreign Application Priority Data
Mar. 7, 2008 (DE) 102008013181.4

(51) Int. Cl. C08J 9/00

(52) U.S. Cl. 521/50.5

(57) ABSTRACT

The present invention concerns a method for the treatment of polyurethane foam, wherein the polyurethane foam is obtainable from a reaction mixture comprising an ethylene oxide/propylene oxide polyol component with an OH number of ≧20 mg KOH/g to ≦45 mg KOH/g and an isocyanate component with an NCO content of ≧20 weight-% to ≦49 weight-% which is selected from the group comprising diphenylmethane diisocyanate, toluene diisocyanate, their prepolymers with an ethylene oxide/propylene oxide polyol whose OH number is from ≧20 mg KOH/g to ≦45 mg KOH/g and/or their allophanates, ureas, biurets, uretdiones, isocyanurates or carbodiimides. The invention further concerns a polyurethane foam which has been treated by such a method. After the foam formation has finished, the polyurethane foam is irradiated with microwave radiation and the irradiated energy, in relation to the volume accessible by the microwave radiation, is from ≧1.0 kilojoules/liter to ≦2.23 kilojoules/liter. Such polyurethane foams may be used as flexible molded foams in furniture applications.

### RELATED APPLICATIONS

This application claims benefit to German Patent Application No. 10 2008 013 181.4, filed Mar. 7, 2008, which is incorporated herein by reference in its entirety for all useful purposes.

### BACKGROUND OF THE INVENTION

The present invention concerns a method for the treatment of polyurethane foam, wherein the polyurethane foam is obtainable from a reaction mixture comprising an ethylene oxide/propylene oxide polyol component with an OH number of ≧20 mg KOH/g to ≦45 mg KOH/g and an isocyanate component with an NCO content of ≧20 weight-% to ≦49 weight-% which is selected from the group comprising diphenylmethane diisocyanate, toluene diisocyanate, their prepolymers with an ethylene oxide/propylene oxide polyol whose OH number is from ≧20 mg KOH/g to ≦45 mg KOH/g and/or their allophanates, ureas, biurets, uretdiones, isocyanurates or carbodiimides. The invention further concerns a polyurethane foam which has been treated by such a method.

Flexible foam articles made out of polyurethane foam, which may for example be used as cushions in the furniture industry, are usually produced in a foaming mold. After removal out of the foaming mold, the final degree of cross-linking of the polyurethane foam has generally not yet been reached. In fact, a subsequent cross-linking reaction takes place. This is of consequence for the production process. If the foam article is compressed before the end of this cross-linking reaction, for example by stacking, packaging or improper storage, pressure marks are retained in the foam article. This lowers the quality of the product.

It is possible to effect this subsequent cross-linking by storing the foam article for a specified time at room temperature. Usually, a time period of 24 hours is considered. After this time the foam article can be packaged or processed further. However, this approach demands providing the respective storage capacities.

Another possibility for more rapidly effecting the cross-linking is to store the foam article for a specified time at elevated temperatures. An example would be a storage at 100° C. for one hour. The disadvantage is that a heating oven with its energy consumption needs to be provided. Moreover, the heat transport to the interior of the foam is slowed down by the insulating properties of the foam.

Microwave radiation has the property that suitable media may be heated volumetrically, meaning evenly throughout the entire volume. In the art, several methods for heating polyurethane material have been described.

DE 38 42 656 A1 discloses a method for the production of cured, mechanically workable polyurethane foam articles, polyurethane formed articles on or polyurethane formed inserts in a support or the like, especially of polyurethane formed articles on or polyurethane inserts in wood or wood/polymer composite plates. The polyurethane is prepared from the starting materials, hardened under heat treatment and then machined mechanically. In this, the polyurethane and optionally also the surrounding support body is heated using microwave radiation.

EP 0 371 309 A2 discloses a method for the preparation of an elastic, polyurethane-based foam, in particular for use in the automotive sector for sound insulation. The method uses dielectric heating for foaming. In order to be able to produce the foam parts directly in the desired shape in the fewest possible operations, it is proposed that a mixture of at least one polyurethane precondensate, at least one melamin precondensate and further additives be used for the foaming. The foaming can take place in a microwave oven.

U.S. Pat. No. 4,131,660 discloses a method of evaluating the probability of scorch in flame retarded flexible polyurethane foams. The method includes heating the foam, which has an internal temperature of about 120° C. to 180° C., with microwaves for about 2 to about 30 minutes. The microwaves have a radiation energy of about 2.5 to 7 kilocalories per minute. Afterwards, the sample is inspected for scorching.

It would be desirable to use microwaves for the volumetric heating of flexible polyurethane articles that have been removed from the foaming mold in order to reduce the time needed for a sufficient cross-linking. However, the formulation of the polyurethane foam needs to be considered. Due to the variable dipole character of the foam components, their crystallinity and the segmentation of the foam as well as further factors it cannot be predicted whether the foam can be cross-linked under economically feasible conditions in a microwave field or whether instead a scorching of the foam interior may occur.

The present invention has the object of overcoming at least one of the drawbacks in the art. In particular, the invention has the object of providing a method for treating a flexible foam article so that the treated articles do not experience interior scorching.

### EMBODIMENTS OF THE INVENTION

An embodiment of the present invention is a method for treating polyurethane foam, wherein said polyurethane foam is obtained from a reaction mixture comprising
an ethylene oxide/propylene oxide polyol component with an OH number in the range of from 20 mg KOH/g to 45 mg KOH/g; and
an isocyanate component with an NCO content in the range of from 20 weight % to 49 weight % and said isocyanate component is diphenylmethane diisocyanate, toluene diisocyanate, their prepolymers with an ethylene oxide/propylene oxide polyol whose OH number is in the range of from 20 mg KOH/g to 45 mg KOH/g and/or
their allophanates, ureas, biurets, uretdiones, isocyanurates or carbodiimides;
   comprising
   after the formation of said polyurethane foam has finished, said polyurethane foam is irradiated with microwave radiation, wherein the irradiated energy of said microwave radiation, in relation to the volume accessible by the microwave radiation, is in the range of from 1.0 kilojoules/liter to 2.23 kilojoules/liter.

Another embodiment of the present invention is the above method, wherein said irradiated energy, in relation to the volume accessible by the microwave radiation, is in the range of from 1.7 kilojoules/liter to 1.8 kilojoules/liter.

Another embodiment of the present invention is the above method, wherein said polyurethane foam is produced in a foaming mold and wherein, before said irradiation with microwave radiation, said polyurethane foam has a surface temperature that is lower than the temperature used during molding.

Another embodiment of the present invention is the above method, wherein said irradiation with microwaves is conducted in such a way that a surface temperature of said polyurethane foam in the range of from 35° C. to 80° C. is reached.

Another embodiment of the present invention is the above method, wherein the power of said microwave radiation is controlled in such a way that the surface temperature of the polyurethane foam does not fluctuate by more than 10% around a pre-determined temperature.

Another embodiment of the present invention is the above method, wherein said microwave radiation has a frequency in the range of from 2.35 GHz to 2.55 GHz.

Another embodiment of the present invention is the above method, wherein the reaction mixture from which said polyurethane foam is obtained further comprises a filler polyether dispersion with in the range of from 10 weight % to 30 weight % filler and an OH number of the polyether in the range of from 20 mg KOH/g to 45 mg KOH/g.

Another embodiment of the present invention is the above method, wherein the reaction mixture from which said polyurethane foam is obtained further comprises a trifunctional polyether polyol with an OH number in the range of from 30 mg KOH/g to 50 mg KOH/g.

Another embodiment of the present invention is the above method, wherein the reaction mixture from which said polyurethane foam is obtained further comprises an ethylene oxide/propylene oxide polyol component with an OH number in the range of from 150 mg KOH/g to 300 mg KOH/g.

Yet another embodiment of the present invention is a polyurethane foam treated by the above method.

### DESCRIPTION OF THE INVENTION

In accordance with the present invention, a method for the treatment of polyurethane foam is suggested wherein the polyurethane foam is obtainable from a reaction mixture comprising an ethylene oxide/propylene oxide polyol component with an OH number of ≧20 mg KOH/g to ≦45 mg KOH/g and an isocyanate component with an NCO content of ≧20 weight-% to ≦49 weight-% which is selected from the group comprising diphenylmethane diisocyanate, toluene diisocyanate, their prepolymers with an ethylene oxide/propylene oxide polyol whose OH number is from ≧20 mg KOH/g to ≦45 mg KOH/g and/or their allophanates, ureas, biurets, uretdiones, isocyanurates or carbodiimides. The method is characterized in that after the foam formation has finished, the polyurethane foam is irradiated with microwave radiation and wherein the irradiated energy, in relation to the volume accessible by the microwave radiation, is from ≧1.0 kilojoules/liter to ≦2.23 kilojoules/liter.

The polyurethane foam which is irradiated in the method according to the invention may be an at least partially flexible foam. The main components of the reaction mixture which results in the foam are firstly an ethylene oxide/propylene oxide polyol with an OH number of ≧20 mg KOH/g to ≦45 mg KOH/g. Here and also in the following context of the invention, the OH number is to be understood as milligrams potassium hydroxide per gram of polyol and can be determined according to the norm DIN 53240. It is also possible that the OH number of this polyol is from ≧20 mg KOH/g to ≦40 mg KOH/g, ≧25 mg KOH/g to ≦35 mg KOH/g or from ≧27 mg KOH/g to ≦30 mg KOH/g. The functionality of the polyol can be in a range of ≧2 to ≦4. The weight ratio of ethylene oxide units to propylene oxide units may be, for example, 50:50, 60:40, 75:25, 40:60 or 25:75.

The second main component is an isocyanate component with an NCO content of ≧20 weight-% to ≦49 weight-%. The NCO content may also be from ≧20 weight-% to ≦40 weight-% ≧25 weight-% to ≦35 weight-% or from ≧28 weight-% to ≦32 weight-%. The NCO content can be determined according to the norm ASTM D 5155-96 A. According to the invention, it is provided that the isocyanate component is selected from the group comprising diphenylmethane diisocyanate (MDI), toluene diisocyanate (TDI) and/or their prepolymers with an ethylene oxide/propylene oxide polyol whose OH number is from ≧20 mg KOH/g to ≦45 mg KOH/g. This OH number may also be from ≧20 mg KOH/g to ≦40 mg KOH/g. Within the scope of the invention as the isocyanate component are reaction products of diphenylmethane diisocyanate and/or toluene diisocyanate to form allophanates, ureas, biurets, uretdiones, isocyanurates or carbodiimides.

Furthermore, the isocyanate component may have a functionality of ≧2 to ≦4. The functionality describes the average number of NCO groups per molecule. Accordingly, the isocyanate can be present in monomeric oligomeric or polymeric form or in mixtures of these. The isocyanate component may furthermore be free from solvents. Especially suited, also for the production of the prepolymers and the reaction products, are 2,2′-, the 2,4′- and 4,4′-isomers of MDI and the 2,4- and the 2,6-isomers of TDI.

The reaction mixture may have a ratio of reactive NCO groups to reactive OH groups of ≦1, of 1 or of ≧1. Another way for expressing this is that the index of the reaction mixture is ≦100, 100 or ≧100. The index may, for example, be ≦95, ≦90 or ≧105.

In the method according to the invention a polyurethane foam article is initially formed, for example by foaming in a mold. After the foam formation has ceased, the microwave irradiation follows. The foam formation is deemed to have ceased when the volume of the formed foam does not increase any more. Hence, the microwave energy is not used to influence the polymer foam formation.

In the context of the present invention, microwave radiation means electromagnetic radiation with a frequency of ≧300 MHz to ≦300 GHz. It is intended that the irradiated energy, in relation to the volume accessible by the microwave radiation, is from ≧1.0 kilojoules/liter to ≦2.23 kilojoules/liter. This relates to the energy of the emitted microwave radiation. In this, the radiation power of the microwaves and the duration of the irradiation form the basis of the calculation.

The volume accessible by the microwave radiation may either be a completely enclosed space into which the microwaves are irradiated. In calculating the volume, a foam article which may be present within is not considered in the calculation. An example for a closed space is the microwave chamber of a microwave oven. The volume accessible by the microwave radiation may also be partially open. An example for this is when a foam slab is transported past a microwave sender on a conveyer belt in a continuous production system. In these not completely enclosed cases the volume accessible by the microwave radiation is regarded as the volume in which the energy of the microwave radiation is ≧10% of the initially emitted value. Here also the foam article which may be present is not considered in the calculation of the volume.

It is also possible that the irradiated energy, in relation to the volume accessible by the microwave radiation, is from ≧1.7 kilojoules/liter to ≦1.8 kilojoules/liter.

Without wishing to be bound by theory, it is assumed that the introduction of energy in the above-mentioned energy ranges leads to a sufficient heating of the polyurethane foam article, without thermally overstressing it. An additional effect is that in suitably chosen, volume specific energies the cross-linking of the resulting polymer can proceed sufficiently so that the foam article can be packaged after less waiting time.

In an embodiment of the present invention the polyurethane foam is produced in a foaming mold and, before the irradiation with microwaves, the polyurethane foam has a surface temperature that is lower than the temperature used during molding. This means that the foam article is made in a foaming mold and cooled before it is irradiated with microwaves. The foam article can cool in the mold or can be removed from the mold and then cooled. The surface temperature of the foam article can reach room temperature, be lower than room temperature or be between room temperature and the molding temperature. By letting the foam article cool down, a thermal equilibration within the foam article is effected. It is possible that the surface temperature after cooling is ≧20% to ≦90%, ≧40% to ≦70% or ≧50% to ≦60% of the molding temperature.

In a further embodiment of the present invention the irradiation with microwaves is conducted in such a way that a surface temperature of the polyurethane foam of ≧35° C. to ≦80° C. is reached. The surface temperature may also be from ≧40° C. to ≦80° C. or from ≧50° C. to ≦70° C. This refers to the surface temperature immediately after the end of the irradiation.

It is furthermore possible that the power of the microwave radiation is controlled in such a way that the surface temperature of the polyurethane foam does not fluctuate by more than 10% around a pre-determined temperature. Hence the surface temperature is the actuating variable in a control system which governs the microwave power. By this incorporation into a control loop an overheating of the foam core due to excessive microwave power can be avoided. The range of fluctuation may also be ±7% or ±5%.

In a further embodiment of the present invention the microwave radiation has a frequency from ≧2.35 GHz to ≦2.55 GHz. Further possible frequencies are in the range of ≧795 MHz to ≦805 MHz, ≧5.75 GHz to ≦5.85 GHz or ≧12.95 GHz to ≦13.05 GHz.

In a further embodiment of the present invention the reaction mixture from which the polyurethane foam was obtained further comprises a filler polyether dispersion with ≧10 weight-% to ≦30 weight-% filler and an OH number of the polyether of ≧20 mg KOH/g to ≦45 mg KOH/g. It is also provided that the OH number of this polyol may be ≧20 mg KOH/g to ≦40 mg KOH/g, ≧25 mg KOH/g to ≦35 mg KOH/g or ≧27 mg KOH/g to ≦30 mg KOH/g. Furthermore, the content of filler may be in a range of ≧15 weight-% to ≦25 weight-% or from ≧18 weight-% to ≦22 weight-%. Examples for suitable filler polyether dispersions are polyurea dispersions (PHD, PUD), disperse styrene-acrylonitrile copolymerisates (SAN), disperse polymer polyols (PMPO) and/or polyisocyanate polyaddition polyols (PIPA).

In a further embodiment of the present invention the reaction mixture from which the polyurethane foam was obtained further comprises a trifunctional polyether polyol with an OH number of ≧30 mg KOH/g to ≦50 mg KOH/g. It is also possible that the OH number of this polyol may be from ≧35 mg KOH/g to ≦45 mg KOH/g or from ≧37 mg KOH/g to ≦40 mg KOH/g.

In a further embodiment of the present invention the reaction mixture from which the polyurethane foam was obtained further comprises an ethylene oxide/propylene oxide polyol component with an OH number of ≧150 mg KOH/g to ≦300 mg KOH/g.

Another aspect of the present invention is a polyurethane foam which has been treated by a method according to the invention. Such a foam may be used as a flexible molded foam in furniture applications, for example for cushions or mattresses.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

The present invention is further described with reference to the following example and comparative example.

### Example 1

In this series of experiments cuboid foam blocks with a size of 490 mm×490 mm×75 mm and a weight of 1.08 kg were prepared according to the following formulation. The reaction mixture had an index (100 NCO/OH) of 90,00.

| Component | Parts |
|---|---|
| Ethylene oxide/propylene oxide polyol with an OH | 76.44 |
| number of 28 mg KOH/g | |
| Polyurea-polyether dispersion with 20 weight-% | 13.38 |
| polyurea and an OH number of 28 mg KOH/g | |
| Trifunctional polyether polyol with an OH number | 5.73 |
| of 37 mg KOH/g | |
| Water | 3.15 |
| Surfactant | 0.48 |
| Amine based catalyst | 0.05 |
| Reactive amine catalyst | 0.76 |
| Tin catalyst | 0.01 |
| Isocyanate component: prepolymer based on MDI with | 51.08 |
| a binuclear content of 76.5%, a polynuclear content | |
| of 15.5% and an NCO content of 30.3 weight-% | |

The forming temperature was 50° C. After removal from the mold the blocks were allowed to cool to a surface temperature of 35° C. Afterwards, the foam blocks were placed into a microwave oven “HEPHAISTOS” from the company Vötsch Industrietechnik. In this oven, the power of the microwaves can be controlled during operation. The foam blocks were irradiated with microwaves. The surface temperature of the foam block was measured continuously using a temperature sensor. The microwave power was controlled in such a way that a surface temperature of 60° C. was reached in 2 minutes. After that the temperature was upheld during the holding time as specified in the following table. The volume of the microwave chamber was 750 liters.

Following this, the packaging of the foam block was simulated. The foam blocks were placed between two parallel plates and compressed to 40% of their original height. In order to simulate pressure marks, four parallel bars with a square cross-section were included so that the foam block was compressed to a height of 3 cm at these locations. The bars were spaced evenly and parallel to an edge of the plates. The outermost two bars were located on one side and the inner two bars were placed on the other side of the foam block. These compressed molded foams were stored at room temperature for 24 hours. The compression was then removed and the molded foams were inspected visually. Immediately after removing the compression and four hours afterwards it was assessed how much the foam blocks had returned to their original shape. A scoring scheme of 1 to 5 was used, where smaller numbers document worse results.

The results are summarized in the following table. In this table, the sample 1A is the reference sample. This means that the foam block was not irradiated with microwaves after removal from the mold. Listed in the table is the energy input per volume, i.e. the total energy that the microwave oven has transmitted to the microwave chamber during heating and holding phases. This energy is referenced to the volume of the microwave chamber of 750 liters. The entry “score 0 h” is the score immediately after removing the compression, the entry “score 4 h” is the score at four hours after removing the compression

| | Holding time | Energy per volume | | |
|---|---|---|---|---|
| Sample | [min] | [kJ/L] | Score 0 h | Score 4 h |
| 1A | — | 0 | 2 | 3 |
| (reference) | | | | |
| 1B | 5 | 2,055 | 4 | 5 |
| 1C | 5 | 2,219 | 3 | 4 |
| 1D | 3 | 1,892 | 4 | 5 |
| 1E | 1 | 1,761 | 5 | 5 |
| 1F | 0 | 1,071 | 4 | 5 |
| 1G | 5 | 2,230 | 3 | 4 |

No scorching of the core was observed in these experiments.

### Comparative Example

In analogy to the foam articles from example 1 that were irradiated with microwaves, foam articles were prepared according to the same experimental procedure, but were instead stored in an oven at 100° C. for a specified time. The following table summarizes the results. The entry “score 0 h” denotes the score directly after ending the compression, the entry “score 2 h” the score for two hours after ending the compression and “score 4 h” the score for four hours after ending the compression.

| | Time in oven | | | |
|---|---|---|---|---|
| Sample | [min] | Score 0 h | Score 2 h | Score 4 h |
| V1A | 120 | 5 | 5 | 5 |
| V1B | 60 | 3 | 4 | 4 |
| V1C | 45 | 2 | 3 | 3 |
| V1D | 30 | 2 | 2 | 2 |
| V1E | 20 | 1 | 1 | 1 |
| V1F | 15 | 1 | 1 | 1 |
| V1G | 10 | 1 | 1 | 1 |
| V1H | 7 | 1 | 1 | 1 |
| V1I | 5 | 1 | 1 | 1 |
| V1J | 3 | 1 | 1 | 1 |
| V1K | 0 | 1 | 1 | 1 |
| V1L | 0 | 1 | 1 | 1 |

No scorching of the core was observed in these experiments.

In evaluating the comparative examples, it is firstly noted that up to an oven time of 20 minutes for all time intervals after the end of the compression the worst possible scores were achieved. A storage time in the oven of 30 minutes still resulted in the second worst score. After a storage time of 45 minutes the scores improved, reaching the maximum possible score after a time of 120 minutes.

In the foam articles that were irradiated with microwaves according to the invention it can be seen that after a few minutes results are achieved that are comparable to those after a much longer storage in the oven. Top scores at four hours after ending the compression are accomplished after 0, 1, 3 and 5 minutes, depending on the microwave energy referenced to the volume of the chamber. In conclusion, an irradiation with microwaves can lead to a significant reduction of the time needed for the additional cross-linking of the foam.

Special attention is drawn to sample E1 where after a holding time of 1 minute, a holding temperature of 60° C., a prior heating time to 60° C. for 2 minutes and an energy of 1,761 kilojoules per liter of the volume of the microwave chamber the same result was obtained as from a storage of the foam article in an oven for 2 hours at 100° C.

1. A method for treating polyurethane foam, wherein said polyurethane foam is obtained from a reaction mixture comprising
an ethylene oxide/propylene oxide polyol component with an OH number in the range of from 20 mg KOH/g to 45 mg KOH/g; and
an isocyanate component with an NCO content in the range of from 20 weight % to 49 weight % and said isocyanate component is diphenylmethane diisocyanate, toluene diisocyanate, their prepolymers with an ethylene oxide/propylene oxide polyol whose OH number is in the range of from 20 mg KOH/g to 45 mg KOH/g and/or their allophanates, ureas, biurets, uretdiones, isocyanurates or carbodiimides;
comprising
after the formation of said polyurethane foam has finished, said polyurethane foam is irradiated with microwave radiation, wherein the irradiated energy of said microwave radiation, in relation to the volume accessible by the microwave radiation, is in the range of from 1.0 kilojoules/liter to 2.23 kilojoules/liter.

2. The method of claim 1, wherein said irradiated energy, in relation to the volume accessible by the microwave radiation, is in the range of from 1.7 kilojoules/liter to 1.8 kilojoules/liter.

3. The method of claim 1, wherein said polyurethane foam is produced in a foaming mold and wherein, before said irradiation with microwave radiation, said polyurethane foam has a surface temperature that is lower than the temperature used during molding.

4. The method of claim 1, wherein said irradiation with microwaves is conducted in such a way that a surface temperature of said polyurethane foam in the range of from 35° C. to 80° C. is reached.

5. The method of claim 4, wherein the power of said microwave radiation is controlled in such a way that the surface temperature of the polyurethane foam does not fluctuate by more than 10% around a pre-determined temperature.

6. The method of claim 1, wherein said microwave radiation has a frequency in the range of from 2.35 GHz to 2.55 GHz.

7. The method of claim 1, wherein the reaction mixture from which said polyurethane foam is obtained further comprises a filler polyether dispersion with in the range of from 10 weight % to 30 weight % filler and an OH number of the polyether in the range of from 20 mg KOH/g to 45 mg KOH/g.

8. The method of claim 1, wherein the reaction mixture from which said polyurethane foam is obtained further comprises a trifunctional polyether polyol with an OH number in the range of from 30 mg KOH/g to 50 mg KOH/g.

9. The method of claim 1, wherein the reaction mixture from which said polyurethane foam is obtained further comprises an ethylene oxide/propylene oxide polyol component with an OH number in the range of from 150 mg KOH/g to 300 mg KOH/g.

10. A polyurethane foam treated by the method of claim 1.
